(19) United States
(12) Patent Application Publication
(10) Pub. No.: US 2004/0114369 A1
(43) Pub. Date: Jun. 17, 2004

(54) Method and apparatus for storing light

(76) Inventor: Elmer L. Layman, Boston, MA (US)

Correspondence Address: Robert K. Tendler, 65 Atlantic Avenue, Boston, MA, 02110, US

(21) Appl. No.: 10/317,365

(22) Filed: Dec. 12, 2002

(51) Int. Cl. F21V 17/02

(52) U.S. Cl. 362/282; 362/322; 362/324; 362/283

(57) ABSTRACT

A method and apparatus is disclosed for storing light in which light from a light source passes through a rotary chopping disk and through an entrance slot in a light box where the chopped light is allowed to accumulate over time within a closed portion of the light box. After the storage process is stopped, sometime later, which may be a matter of days, the light source in the box is turned on and the light exiting the light box is detected, with the amount of output light increased over the amount of input light due to the storage of light energy within the light box. The amount of light stored in this manner is proportional to the pulse repetition frequency of the light pulses, with the spinning disk having apertures therethrough. The pulse repetition frequency may be multiplied through the utilization of cascaded rotating apertured disks positioned along the light path between the light source and the entrance slot of the light box.

### FIELD OF INVENTION

This invention relates to light storage, more particularly to a method and apparatus for storing pulsed light in a light box, with readout of the stored light being accomplished through a introducing a light beam through the storage area.

### BACKGROUND OF THE INVENTION

Light boxes in general have been known and are utilized for calibration purposes in terms of calibrating the output of a light source. It is a characteristic of the light box that no light is allowed to escape such that all the light in the chamber may be accurately measured by a detector in the light box. The light box has been referred to as a black body device in which all of the light generated within the box is collected.

Up until the present invention, it was not considered that any of the light introduced into the light box would accumulate or could be stored.

Moreover, as is known, the chopping of a light beam is in some sense traumatic to the characteristics of the light. Light has several characteristics that do not vary, namely velocity, refraction, reflection and direction of travel. Chopping of light by whatever means alters these, characteristics. Most notably, the velocity of light is conjunctively changed by chopping and it is the subject the present invention to take advantage of changes in characteristics of chopped light in order to provide for the storage thereof.

### SUMMARY OF THE INVENTION

In the subject invention chopped light is introduced into a light box where it is stored for readout through the introduction of a light beam into the light box, with the lumens associated with the exiting light beam being augmented by the compounded light which exists within the light box due to the chopping of the light and its introduction into the light box.

Compounded light is light disconnected from the light source and packed into the light box chamber. The energy stored in the light box is reintroduced into a probing beam such that the total energy in the probing beam is augmented by the light stored in the light box through the compounding which is a result of light chopping.

In so doing, using collimated light chopped by a chop wheel and introduced into the light box through a stop or mask which forms the entrance aperture into the light box results in light packets that are created within the light box which are invisible.

In one explanation of the subject invention, when the chop wheel chops the light beam the photons lose connection with the light source meaning that they lose any connection in terms of direction of travel, visibility, speed and refraction. This lost connection is sensed by the light source which acts to intensify its output.

Thus, in the subject invention, stored lightis rejuvenated and or created through the use of the original light box which adds to the light from the energy source to yield compounded light having new strength and directionality but not necessarily visibility. In short with subject technique, the original light source is combined with light packets which combine to provide a brighter light.

In the experiments to be described hereinafter there is a so-called on/on mode which the light source is turned on and then the chopper motor is turned on. Packets of light are then built up in the light box and can last several days or longer.

When light from the original light source is reintroduced into the light box without chopping, the light picks up energy from the light packets stored within the light box, thus to increase the strength of the light exiting the light box's chamber.

Light is extracted by opening an exit port of the chamber during the probing of the chamber by the original source and measuring the light output both in the chopper mode and the non-chopper mode.

In quantifying the light storage result an ammeter is utilized to measure the amps pulled by the light source. In the on/on condition 0.82 amps was pulled by the light source to be, contrasted with the on/off condition which results in 0.83 amps. The size of the difference is small but changes of 0.01 amps are significant.

One plausible explanation is that there is a relationship between the broken light beam and the light source. The light source detects the break and instantly acts to repair the light beam by generating more light. The repair includes transmitting energy sufficient to continued communication with the light beam.

In one experiment, the light measured by a light detector is two to three times stronger than the compounded light packet intensity, indicating the amplified behavior at the exit port.

### BRIEF DESCRIPTION OF THE DRAWINGS

These and other features of the subject invention will be better understood with connection with the Detailed Description in conjunction with the Drawings, of which:

FIG. 1 is a diagrammatic illustration of the subject chopped-light light box which forms a light pulse machine, indicating the presence of compacted light within the light box, also indicating an exit aperture which may be controlled from ⅛^{th} open to full open;

FIG. 2 is a waveform diagram of the pulse repetition frequency of the chopped light within the light box of FIG. 1;

FIG. 3 is a diagrammatic illustration of two diametrically opposed apertures in the light chopping wheel used in the apparatus of FIG. 1, illustrating the relationship between the diameter of the apertures and the spacing of the apertures about the periphery of the disk;

FIG. 4 is a bar graph illustrating the change in energy between the on/on condition and an on/off condition, indicating the addition of energy into a probing light beam;

FIG. 5 is a graph showing the amount of stored energy between the on/on condition and on/off condition for various apertures at the exit of the light box of FIG. 1; and,

FIG. 6 is a diagrammatic illustration of the utilization of two chopping disks with two different motor drives, thus to be able to increase the pulse repetition frequency of the chopped light.

### DETAILED DESCRIPTION

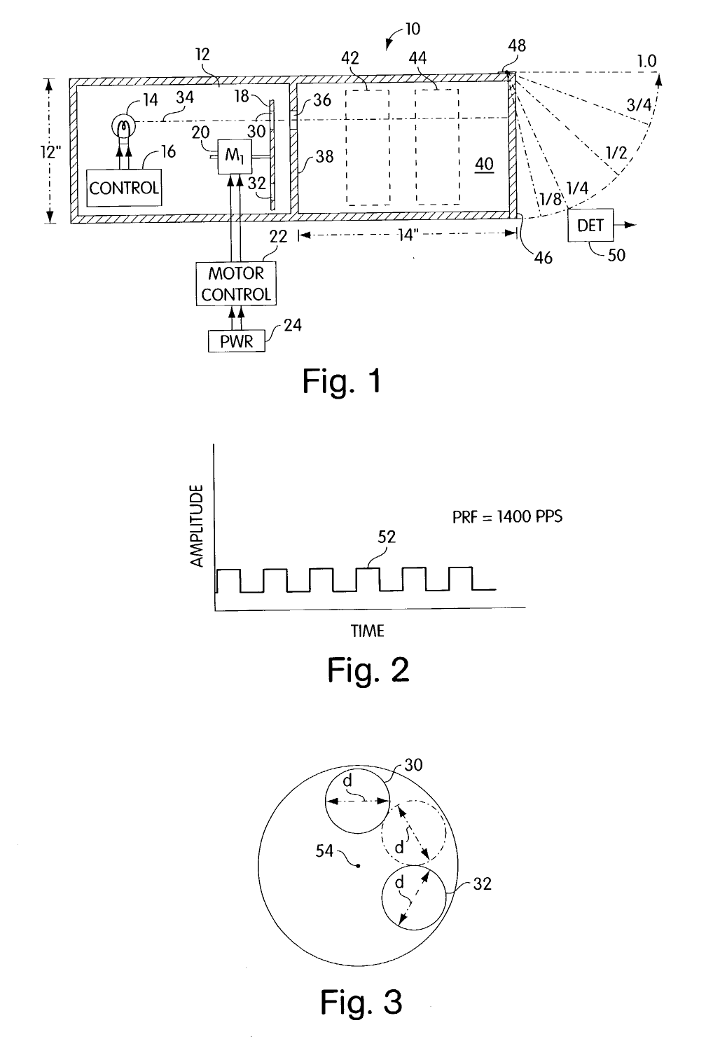

Referring now FIG. 1, a light pulse machine 10 is comprised of a chamber 12 housing a light source 14 controlled by a control unit 16 and a chopper disk 18 driven by a motor 20 under control of a motor control unit 22 coupled to a D.C. power source 24.

Disk 18 has a number D of apertures 30 with a line 34 through an aperture and through a further aperture 36 in a mask or wall 38 of a light box chamber 40 showing when aperture 30 is in aligmnment with aperture 36 light from source 14 is introduced into chamber 40.

When source 14 is turned on by control 16 and motor 22 drives disk 18 at a predetermined RPM, then the chopped light enters chamber 40 and is compacted as illustracated by dotted lines 42 and 44 in light box chamber 40.

End 46 on light 40 is hingedly attached at 48 such that when opened at the indicated angles the exit aperture at 46 of light box chamber 40 shows that thew end 46 forms a gate which is either ⅛^{th} opened, ¼^{th} opened, or ½ opened, ¾^{ths} opened or fully opened as illustrated.

Light which exits light box chamber 40 and the chamber thereof is detected by a detctor 50.

As will be shown, experiments verify that the lumens in the on/on condition, meaning that the disk is turning and the light source is operational is lower than the defected lumens in the on/off condition when light source 14 is on and the disk 18 is hot driven, but with aperture 46 being in alignment with aperture 36.

In one sense, light from soure 14 is used to probe the energy in light box chamber 40 for the readout of this energy 4 along with the energy associated with source 14 such that the total detected energy increases. This can be explained by the fact that energy is in fact stored in the light box for reuse when probed by a probing beam.

The amount of energy stored in this manner is dependent upon pulse repetition frequency of the pulses of light through aperture 36. As shown in FIG. 2, the waveform of the pulse light is illustrated at 52 and has a pulse repetition frequency in one embodiment of 1400 pulses per second.

It will be appreiated that spinning a wheel at 6000 RPM generates 100 pulses per second, with two holes resulting in 200 pulses per second. With four holes in the disk this would be 400 pulses per second.

When, as will be seen, two disks and two motors are utilized, the pulse repetition frequency can be multiplied.

In a preferred embodiment of the subject invention, referring now to FIG. 3, the diameter of apertures 30 and 32 are equal, with the spacing of the apertures side by side around the disk at its periphery also being equal to the diameter of the apertures. Here the center of shaft is illustrated at 54.

The result of one experiment is represented in Table 1 in which the total pulse repetition frequency was 1400 PCS.

TABLE I

| | | X100 | | | |
|---|---|---|---|---|---|
| | | Plot | I X AV29 | | |
| Fractional | | On/On Mode | | On/Off Mode | |
| Area | 12″ × 14″ | Lumens | (x Area) | Lumens, | (x Area) |
| ⅛ | 21 | 36 | 754 | 44 | 924 |
| ¼ | 42 | 32 | 1344 | 36 | 1512 |
| ½ | 84 | 25 | 2100 | 26 | 2184 |
| ¾ | 126 | 20 | 2520 | 24 | 3024 |
| 1.0 | 168 | 19 | 3192 | 25 | 4200 |

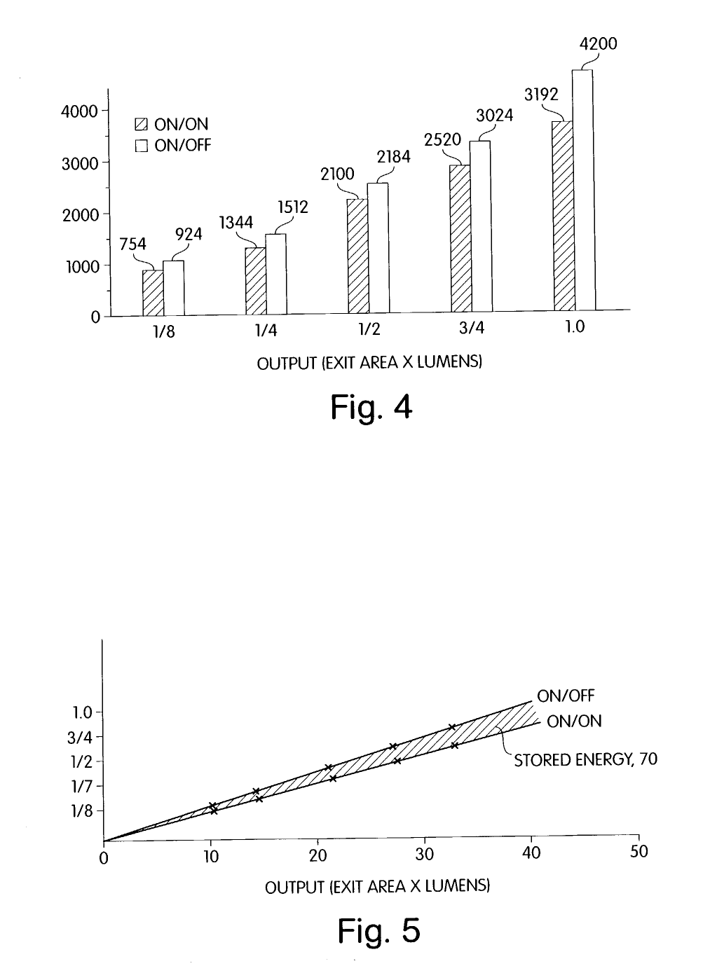

The light introduced to light box cavity 40 took place over 15 minutes and the result of probing the cavity three days later are tabulated in FIG. 4. As can be seen for a ⅛^{th} size exit aperture for chamber 40, the total number of lumens times the aperture area is 754, whereas after probing this grew to 924. For a 14^{th} open aperture, the relative values are 1344 for the on/on condition and 1512 for the on/off condition.

For ½ open these same on/on on/off measurements are 2100 and 2184 respectively; with ¾ opening data indicating 2520/3024 and for the full open condition 3192/4200.

The results are also tabulated in graph form in FIG. 5 in which the stored energy, here illustrated at 70 is shown to be significant.

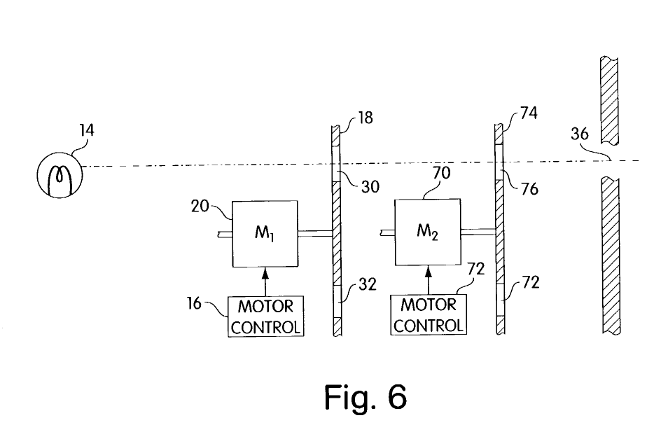

Referring now to FIG. 6 in an alternative embodiment a serial disk configuration is shown in which motor 20 with disk 18 is placed in front of a further motor 20 under the control of motor control unit 72 which drives a disk 74. Disk 74 has its own apertures 76 and 78, with the light beam being double chopped in this configuration to pass through aperture 36.

It will thus be appreciated that the effective pulse repetition frequency or rate of the chopped pulses may be varied through the utilization of this tandem motor technique, with the pulse repetition frequency being optmized for the particular light box cavity involved.

In one embodiment, the light box cavity was 14 inches long with a cross section of 12 inches by 12 inches.

It is a matter of experiment as to the matching of the pulse repetition frequency with a maximumin the amount of stored light energy.

Having now described a few embodiments of the invention, and some modifications and variations thereto, it should be apparent to those skilled in the art that the foregoing is merely illustrative and not limiting, having been presented by the way of example only. Numerous modifications and other embodiments are within the scope of one of ordinary skill in the art and are contemplated as falling within the scope of the invention as limited only by the appended claims and equivalents thereto.

What is claimed is:

1. A method for storing light comprising the steps of:
generating a chopped light beam by chopping light from a light source;
introducing the chopped light beam into a chamber having an exit aperture;
turning off the chopped light beam;
introducing an un-chopped light beam from the light source into the chamber, and,
collecting light from the exit aperture of the chamber, the intensity of light increased over that associated with the chopped light beam, thus to indicate light storage.

2. The method of claim 1, wherein the chopped light beam is generated by passing light from the light source through an aperture in a rotating disk chopper.

3. The method of claim 2, wherein the disk includes multiple apertures.

4. The method of claim 3, wherein the apertures are circular and have equal diameters.

5. The method of claim 4, wherein the apertures are spaced about the periphery of the disk, with interaperture spacing equaling the diameter of the apertures.

6. The method of claim 1, wherein the amount of light stored in the chamber is proportional to the pulse repetition frequency of the chopped light beam.

7. The method of claim 2, wherein the amount of light stored is proportional to the size of the aperture.

8. Apparatus for storing light, comprising:
a light tight chamber having two cavities separated by a wall having an aperture therethrough;
a light source and a motor driven chopping wheel having an aperture, said light source and chopping wheel located in one of said cavities, the aperture in said chopping wheel being rotatable to a position along an axis from said light source and through the aperture in said wall;
a control unit for turning said light source on and off and for powering said motor driven chopping wheel; and,
an exit aperture for the other of the cavities in said chamber out of which stored light emanates, whereby light is stored in the other of the cavities of said chamber when said light source and chopping wheel are tuned on, with the stored light being read out from said chamber at said exit aperture as combined light when said light source is turned on and said chopping wheel is turned off with the aperture in said chopping wheel positioned on said axis.

9. The apparatus of claim 8, wherein said chopping wheel includes multiple apertures about the periphery thereof.

10. The apparatus of claim 8, and further including a second motor driven chopping wheel having at least one aperture, said second chopping wheel being positioned in a cascaded arrangement with respect to the first of said motor driven chopping wheels such that light from said light source first passes through an aperture in the first of said chopping wheels followed by passing through an aperture in the second of said chopping wheels when the apertures of said chopping wheels lie on said axis.

11. The apparatus of claim 8, wherein said exit aperture includes a hinged element at one end of the other of said cavities.

12. The apparatus of claim 11, wherein the amount of light stored is proportional to the amount of opening associated with positions of said hinged element.
